(19) United States
(12) Patent Application Publication
(10) Pub. No.: US 2008/0318532 A1
(43) Pub. Date: Dec. 25, 2008

(54) SYNCHRONIZATION DETECTION

(75) Inventor: MARIKO MATSUMOTO, Tokyo (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC CORPORATION, Tokyo (JP)

(21) Appl. No.: 12/126,453

(22) Filed: May 23, 2008

(30) Foreign Application Priority Data
Jun. 22, 2007 (JP) 2007-165057

(51) Int. Cl. H04B 7/005

(52) U.S. Cl. 455/71

(57) ABSTRACT

A transmitter for transmitting a synchronization signal for establishing synchronization, and a receiver for establishing the synchronization by detecting the synchronization signal are included, and the receiver tries to detect the synchronization signal sequentially at a frequency in which the probability that an effective frequency exists is higher to a frequency in which the existence probability is lower among a plurality of discrete frequency bands.

This application is based upon and claims the benefit of priority from Japanese Patent Application No. 2007-165057 filed on Jun. 22, 2007, the content of which is incorporated by reference.

### BACKGROUND OF THE INVENTION

1. Field of the Invention

The present invention relates to a communication system, a receiver, and a synchronization detecting method for detecting an effective frequency for transmitting and receiving information from a plurality of candidate frequencies.

2. Description of the Related Art

Generally, in a communication system having a mobile station such as a portable terminal, a plurality of frequencies are defined as the frequency for a down signal transmitted from a base station to the mobile station. One frequency or a plurality of frequencies are selected from among such a plurality of frequencies, and the down signal is transmitted by using the selected frequencies.

For example, in 3GPP (3rd Generation Partnership Project), which is a specification of W-CDMA (Wideband Code Division Multiple Access), as illustrated in FIG. 1A, 276 frequencies which are referred to as Raster are set at an interval of 200 kHz in a frequency area that eliminates both sides of 2.5 MHz from 2110 MHz to 2170 MHz. An effective frequency is selected from among the set frequencies, and the down signal is transmitted by using a transmission band whose center is the selected effective frequency. Meanwhile, the Raster is defined as a minimum unit for allocating a central frequency in the transmission band of a system.

When turning on an electric power source, or detecting to be outside the range, the mobile station detects the effective frequency from among the candidate frequencies, and establishes synchronization between the mobile station and the base station. This process for detecting the effective frequency is referred to as a band search process. A well-known signal referred to as a synchronization signal may be used to detect the effective frequency. As a method for speeding up the band search process, Japanese Patent Laid-Open No. 2003-244083 discloses a method for blocking a plurality of adjacent frequencies.

In Release 7 of 3GPP, as described in [3GPP TR 25. 814. V1.1.1 (2006-2) Physical Layer Aspects for Evolved UTRA (Release 7) Chapter 7.1.1], such a method is being studied in which a plurality of transmission band widths (1.25, 2.5, 5,10, 15, 20 MHz) from a narrow band to a wide band can be set within a frequency band owned by an operator.

Regarding a system in which such a plurality of band widths can be set, [3GPP R1-060311 SCH Structure and Cell Search Method for E-UTRA DownLink] discloses such a method in which the central frequencies of a plurality of band widths are caused to be the same, and are caused to be an integral multiple of the Raster, and in which the synchronization signal (SCH: Synchronization Channel) is allocated in a central band.

As a general method, in some systems, a priority is attached to a frequency used for the communication. Japanese Patent No. 2814782 and Japanese Patent Laid-Open No. 1988-158926 disclose such a method in which the effective frequency detection is accelerated by trying to sequentially detect the effective frequency from the frequency whose priority is higher since the frequency whose priority is higher is a frequency whose probability for detecting the effective frequency is higher.

On the other hand, as well as Release 7 of 3GPP, 3GPP Long Term Evolution (LTE), WiMAX, in recent years, OFDM (Orthogonal Frequency Division Multiplexing)/OFDMA (Orthogonal Frequency Division Multiplexing Access), whose multi-pass tolerance is excellent, tends to be used for mobile communication. At that time, since a parameter such as a sub-carrier interval is set, taking into consideration fading tolerance, the sub-carrier interval may not be an integral multiple of the Raster, and it becomes difficult to simplify the band search process and the synchronization process.

In [3GPP TR 25. 104. V7.6.0 (2007-3) Base Station (BS) radio transmission and reception (FDD) (Release 7) Chapter 5] of Release 7 and LTE of 3GPP, many channel bands are defined which are discrete frequency bands. This is because a frequency band in which a service can be provided differs depending on the country type. The following is a problem. In international roaming, it is necessary for a terminal to band search(search the frequency band) such many channel bands, so that a calculation time and power consumption are increased.

As illustrated in FIG. 1B, in the band search for the plurality of channel bands by a related method, first, a search band of channel band 1 is band-searched at a 200 kHz interval, and when the effective frequency is not detected, channel band 2 is band-searched at a 200 kHz interval.

However, the following is a problem in the above method. Since the existence of the effective frequency is sequentially detected for the many set candidate frequencies, the time that is needed to execute the band search process for detecting the effective frequency becomes longer.

The following is a problem. A large amount of calculation is necessary to sequentially search the existence of an effective wave for many frequencies. And also, when OFDM is used as a transferring scheme, if the sub-carrier interval is not a integral multiple of the Raster, an intermediate result, and the like can not be mutually referred to in a calculation for each candidate frequency, so that the amount of calculation can not be reduced, and thereby, electric power consumption needed for executing the band search process becomes larger.

### SUMMARY OF THE INVENTION

An object of the present invention is to provide a communication system, a receiver, and a synchronization detecting method which can also quickly realize an effective frequency detecting process when detecting a plurality of channel bands.

In the present invention for achieving the above object, in a communication system including a transmitter for transmitting the synchronization signal for establishing the synchronization, and in a receiver for establishing the synchronization by detecting the synchronization signal, the receiver tries to detect the synchronization signal sequentially at a frequency in which the probability that an effective frequency exists is higher to a frequency in which the existence probability of the effective frequency is lower among a plurality of discrete frequency bands.

As described above, in the present invention, when detection of the synchronization signal from among a plurality of discrete frequency bands is tried, in the receiver, a process for detecting an effective frequency from among a plurality of frequency bands can be quickly realized by detecting the synchronization signal of the frequency whose the probability that an effective frequency exists is lower after detecting the synchronization signal of the frequency whose the probability that an effective frequency exists is higher of each of a plurality of frequency bands for the frequencies in which the synchronization signal is tried to be detected.

The above and other objects, features, and advantages of the present invention will become apparent from the following description with reference to the accompanying drawings which illustrate an example of the present invention.

### BRIEF DESCRIPTION OF THE DRAWINGS

FIG. 1A is a diagram modeling a frequency area for describing a band search which is a general frequency area search;

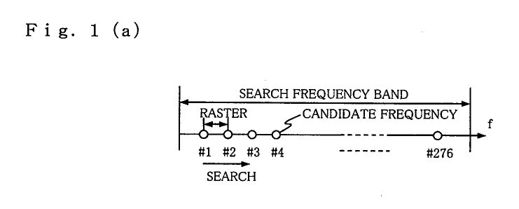

FIG. 1B is a diagram illustrating an example of the band search for a plurality of channel bands by a general method;

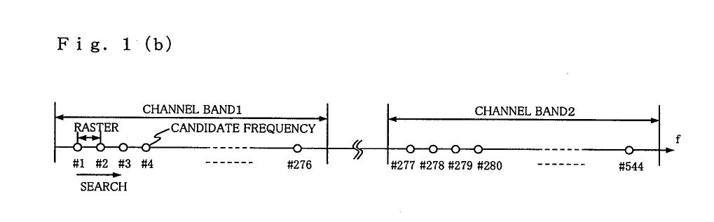

FIG. 2 is a diagram illustrating an exemplary embodiment of a communication system of the present invention;

FIG. 3A is a flowchart describing a parallel band search for a synchronization channel in the exemplary embodiment illustrated in FIG. 2;

FIG. 3B is a flowchart illustrating an application of FIG. 3A;

FIG. 4A is a diagram modeling a frequency area of a first stage for describing a staged search for the synchronization channel in the exemplary embodiment illustrated in FIG. 2;

FIG. 4B is a diagram modeling a frequency area of a second stage for describing the staged search for the synchronization channel in the exemplary embodiment illustrated in FIG. 2;

FIG. 4C is a diagram modeling a frequency area of a third stage for describing the staged search for the synchronization channel in the exemplary embodiment illustrated in FIG. 2;

FIG. 5 is a flowchart describing a synchronization detecting method in a stage band searching method in a receiver of the communication system illustrated in FIG. 2;

FIG. 6 is a flowchart obtained by further embodying the flowchart illustrated in FIG. 5;

FIG. 7A is a diagram modeling a first stage process of a stage band search process described by using the flowchart illustrated in FIG. 6;

FIG. 7B is a diagram modeling a second stage process of the stage band search process described by using the flowchart illustrated in FIG. 6;

FIG. 7C is a diagram modeling a third stage process of the stage band search process described by using the flowchart illustrated in FIG. 6;

FIG. 7D is a diagram modeling a fifth stage process of the stage band search process described by using the flowchart illustrated in FIG. 6;

FIG. 8A is a flowchart describing such a case in which the stage band search method is used in the flowchart illustrated FIG. 3A;

FIG. 8B is a flowchart illustrating an application of FIG. 8A;

FIG. 9 is a flowchart describing a procedure for determining a transmission frequency of the synchronization signal in the stage band search method in a transmitter of the communication system illustrated in FIG. 2;

FIG. 10 is a flowchart describing another determining method for the procedure for determining the transmission frequency of the synchronization signal in the stage band search method in the transmitter of the communication system illustrated in FIG. 2;

FIG. 11A is a diagram modeling an allocation of the synchronization signal of the stage band search method in a frequency area in such a system in which the transmission band is TBW_s1=5 MHz, and in which an OFDM signal formed with the 301 sub-carriers is transmitted;

FIG. 11B is a diagram modeling the allocation of the synchronization signal of the stage band search method in a frequency area in such a system in which the transmission band is TBW_s2=1.25 MHz, and in which the OFDM signal formed with the 705 sub-carriers is transmitted;

FIG. 12 is a diagram modeling a time area and a frequency area of the general sub-carrier in LTE of 3GPP;

FIG. 13 is a diagram modeling a time area and a frequency area of the sub-carrier in the stage band search method;

FIG. 14 is a diagram modeling a time area and a frequency area of the sub-carrier when the stage band search method is used in a system in which it is not necessary to provide a DC sub-carrier;

FIG. 15 is a diagram modeling the sub-carrier on a frequency axis when the synchronization signal is transmitted in a system in which the DC sub-carrier is provided;

FIG. 16 is a diagram modeling the sub-carrier on a frequency axis when the synchronization signal is transmitted in the system in which it is not necessary to provide the DC sub-carrier;

FIG. 17 is a diagram illustrating an exemplary embodiment when the communication system of the stage band search method is applied to a wireless communication system using a wireless communicating scheme;

FIG. 18A is a diagram illustrating a first exemplary embodiment when another configuration is used for a part illustrated by the dash line in the exemplary embodiment illustrated in FIG. 17; and

FIG. 18B is a diagram illustrating a second exemplary embodiment when another configuration is used for the part illustrated by the dash line in the exemplary embodiment illustrated in FIG. 17.

### EXEMPLARY EMBODIMENT

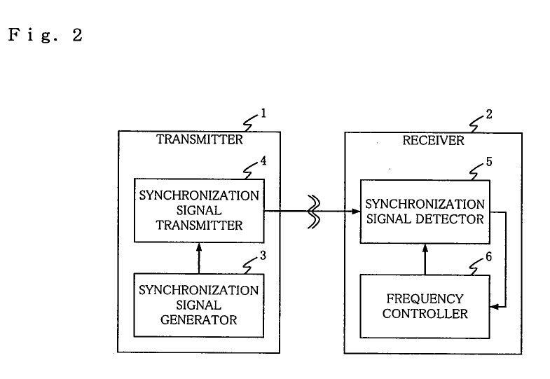

FIG. 2 illustrates an exemplary embodiment of a communication system configured with transmitter 1 which is a transmitter and receiver 2 which is a receiver that communicates with transmitter 1. Transmitter 1 is configured with synchronization signal generator 3 and synchronization signal transmitter 4. Receiver 2 is configured with synchronization signal detector 5 and frequency controller 6. Synchronization signal generator 3 generates the synchronization signal for synchronizing between transmitter 1 and receiver 2. Synchronization signal transmitter 4 transmits the synchronization signal generated by synchronization signal generator 3. Frequency controller 6 outputs a frequency for detecting the synchronization signal transmitted from transmitter 1 to synchronization signal detector 5. Synchronization signal detector 5 detects the synchronization signal by using the frequency outputted from frequency controller 6, and notifies the detection result to frequency controller 6.

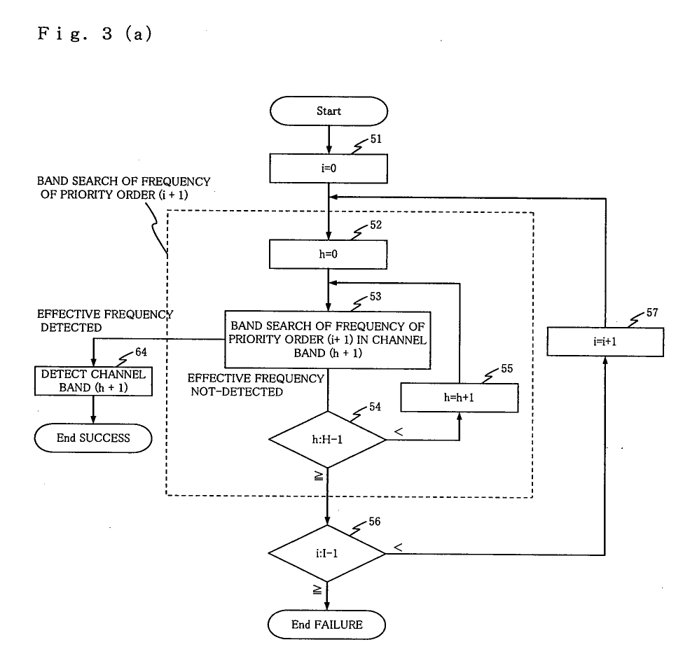

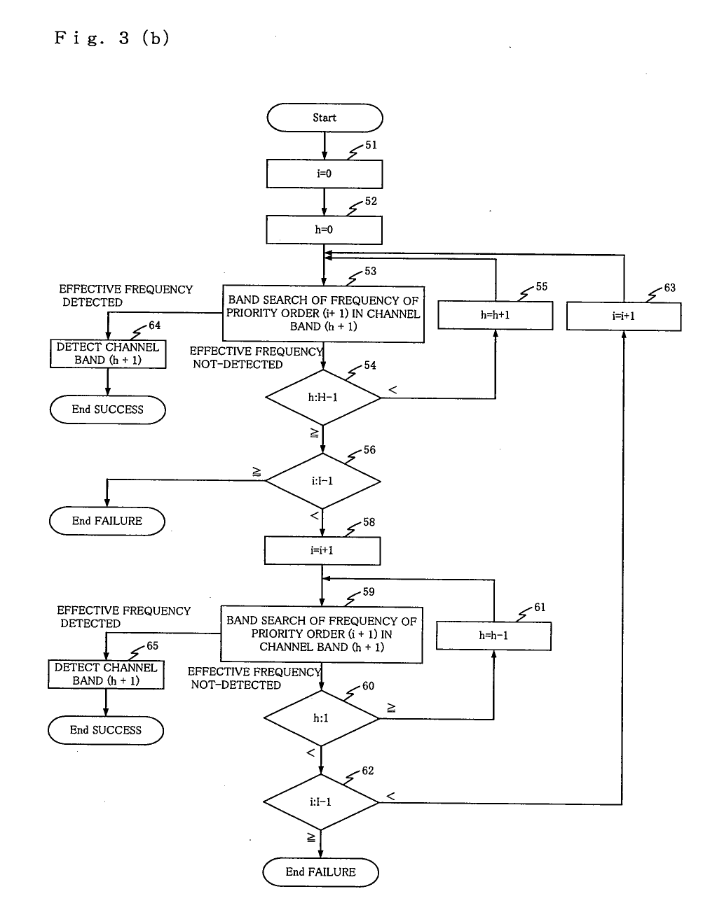

A parallel band search of the synchronization channel of the exemplary embodiment illustrated in FIG. 2 will be described below referring to FIG. 3A.

This is such an exemplary embodiment that channel bands 1 to H which are a plurality of discrete frequency bands are band-searched when frequencies whose priority orders are 1 to I are set based on the probability that an effective frequency exists. In this case, while the frequencies whose priority orders are 1 to I are set based on the probability that an effective frequency exists, the total number of the frequencies whose priority orders are 1 to I in each channel band is equal to the number of all frequencies in which the effective frequency of each channel band can exist.

First, at step 51, a parameter i is set to “0” which is an initial value, and at step 52, a parameter h is set to “0” which is an initial value. At step 53, the frequency whose priority order is 1 in channel band 1 is band-searched (synchronization detection try). When the effective frequency is detected, the process is completed, however, as an additional function, channel band (h+1) can be also specified at step 64.

On the other hand, when the effective frequency is not detected at step 53, a determination is made at step 54 whether or not the band search for the frequency whose priority order is 1 for all H channel bands has been completed. When the band-search is not completed, the process moves to the next channel band at step 55, and the frequency whose priority order is 1 in channel band 2 is band-searched at the above step 53.

On the other hand, if it is determined at step 54 that the band search of the frequencies, whose priority order is 1 for all H channel bands, has been completed, a determination is made at step 56 whether band searching the effective frequencies of all I priority orders has been completed. If a determination is made that a band search for the effective frequencies of all I priority orders has not been completed, the process moves to next priority order at step 57, and at the above step 52, the parameter h is set to “0” which is an initial value, and at the step 53, the frequency whose priority order is 2 in channel band 1 is band-searched.

On the other hand, if a determination is made at step 56 that band searching for the frequencies of all I priority orders has been completed, a conclusion is made that an effective frequency does not exist in all the channel bands.

By utilizing channel band information specified at step 64, in the fixed channel band, it is also possible to band-search the frequencies of all the priority orders in more detail, and to specify area information of a country, and the like from the relation between the previously-stored channel band information and the area information.

An application of FIG. 3A will be described by referring to FIG. 3B.

Operation of steps 51 to 55 and step 64 are the same as those of FIG. 3A.

If the determination is made at step 54 that a band searching of frequencies, whose priority order is 1 of all H channel bands, has been completed, a determination is made at step 56 whether band searching the effective frequencies of all I priority orders has been completed. If it is determined that it is not completed to band-search the effective frequencies of all of I priority orders, the process moves to next priority order 2 at step 58. In this case, since h=H−1, the frequency of the priority order 2 in channel band H is band-searched at step 59. When the effective frequency is detected, channel band (h+1) is specified at step 65, and the process is completed.

On the other hand, when the effective frequency is not detected at step 59, a determination is made at step 60 whether band searching for the frequencies of the priority order 2 in all H channel bands has been completed. When a determination is made that a band searching for the frequencies of the priority order 2 in all H channel bands has been completed, the h is subtracted by “1” at step 61, the process moves to next channel band, and at step 59, the frequency of the priority order 2 of channel band H−1 is band-searched.

On the other hand, if a determination in made at step 60 that band searching for the frequencies of the priority order 2 in all H channel bands has been completed, a determination is made at step 62 whether or not band searching for the effective frequencies of all of I priority orders has been completed. When a determination that band searching for the effective frequencies of all I priority orders has been completed, is made at step 63, the process moves to the priority order 3. In this case, since h=“0”, at step 53, the frequency of the priority order 3 in channel band 1 is band-searched.

On the other hand, if a determination in made at step 62 that band searching for the frequencies of all of I priority orders has been completed, a determination that the effective frequency does not exist in all channel bands.

The following is an advantage of this method. The h is not frequently initialized in FIG. 3B as compared with FIG. 3A, so that the channel band in which the detection is tried is not changed so often.

By utilizing the channel band information specified at step 64 or step 65, in the fixed channel band, it is also possible to band-search the frequencies of all the priority orders in more detail, and to specify area information of a country, and the like from the relationship between the previously-stored channel band information and the area information.

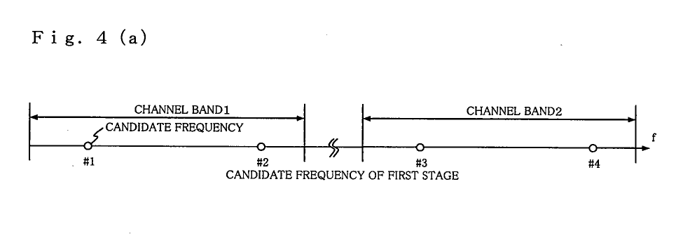

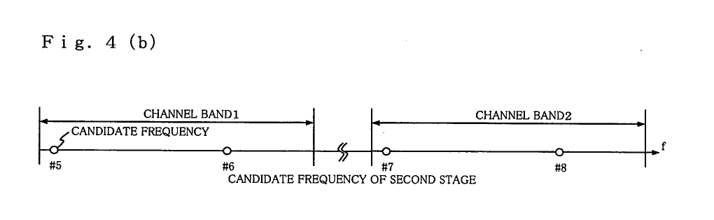

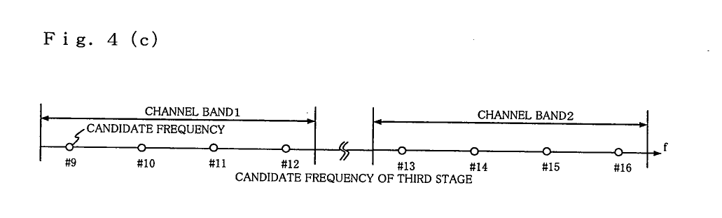

As illustrated in FIG. 4, frequency controller 6 of receiver 2 outputs the candidate frequency for detecting the synchronization signal as sequentially and gradually switching from a roughly thinned frequency to a not-thinned frequency between channel band 1 and channel band 2, and the frequency gap between channel band 1 and channel band 2 is not band-searched. In this case, the stage band search method is used as an exemplary embodiment of the band search which includes priority orders.

FIG. 4A illustrates the candidate frequencies whose priority orders are high, for which the synchronization detection has been tried at the first stage, and hereinafter, FIG. 4B illustrates the candidate frequencies of the second stage, and FIG. 4C illustrates the candidate frequencies of the third stage. As the stage advances, and the priority order becomes lower, the interval of the candidate frequency becomes narrower.

The frequency gap between channel band 1 and channel band 2 is not band-searched.

In transmitter 1, the transmission frequency of synchronization signal transmitter 4 is set so that the synchronization signal is added to the early stage of the frequency outputted by frequency controller 6 of receiver 2. Thereby, the effective frequency existence probability of the early stage is increased.

It is sufficient that the synchronization signal generated by synchronization signal generator 3 of transmitter 1 is a signal obtained by repeating the same pattern on a time axis, or a signal which is well-known between a transmitter and a receiver. When the synchronization signal is repeated at the same pattern on a time axis, synchronization signal detector 5 of receiver 2 detects the same pattern by using delay wave detection, and when the synchronization signal is a well-known pattern detector 5, tries to detect the synchronization signal by using synchronization wave detection. The synchronization signal and a configuration of a detector thereof do not limit the effect of the present invention, and may not be limited by any reasons.

As disclosed in Japanese Patent Laid-Open No. 2003-244083, the use of electric power is detected for each of a plurality of blocks obtained by dividing a search frequency band and a band search process that is limited to the band, whose consumption of electric power has been detected, may be executed according to a method of the present invention.

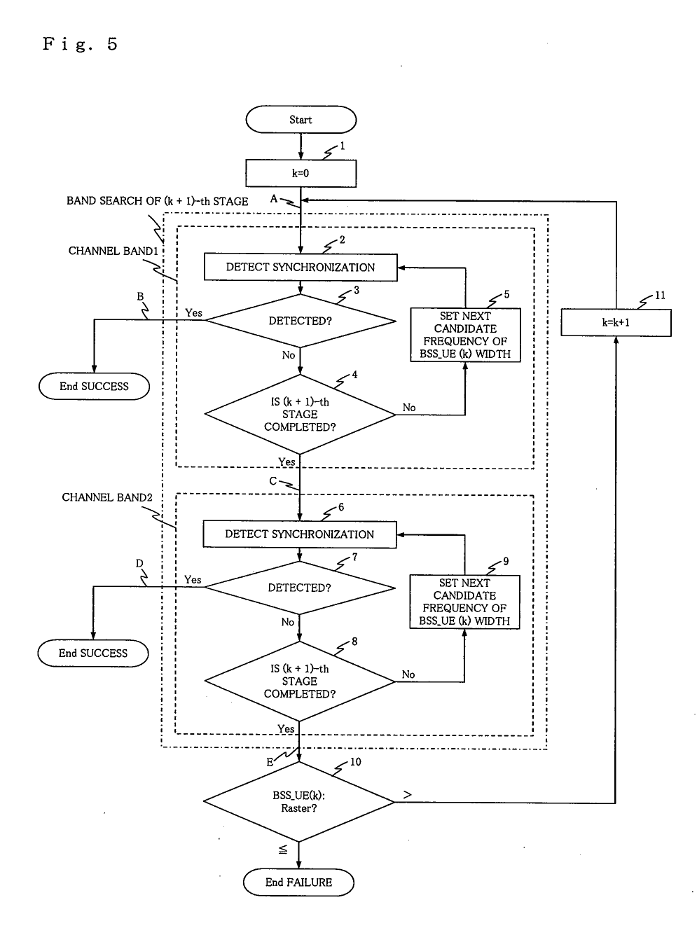

The synchronization detecting method in the communication system illustrated in FIG. 2 will be described below by referring to FIG. 5.

Such an exemplary embodiment will be described in which channel band 1 and channel band 2 are searched in parallel. In this case, the stage band search method is used as an exemplary embodiment of the band search which includes the priority order.

Here, BSS_UE (k) is designated as an amount of receiving side frequency change (band search step) in the band search of the (k+1)-th stage, and is defined as illustrated in Table 1.

### [Table 1]

TABLE 1

| k | 0 | 1 | 2 | 3 | 4 |
|---|---|---|---|---|---|
| BSS_UE (k) | 3.2 MHz | 1.6 MHz | 800 kHz | 400 kHz | 200 kHz |

First, at step 1, a parameter k is set to “0” which is an initial value, and in channel band 1, synchronization detection is executed at step 2 for the receiving side candidate frequency whose priority order is high, and whose width is BSS_UE (0). It is determined at step 3 whether or not the effective frequency has been detected, and when the effective frequency has been detected, the process is completed.

On the other hand, when the effective frequency is not detected, it is determined at step 4 whether or not next receiving side candidate frequency by the band search of the BSS_UE (0) width exists in channel band 1. That is, a simple exemplary embodiment will be specifically described. When the search frequency band in which synchronization detection of the effective frequency is executed is 2000 MHz to 2005 MHz, if the candidate frequency for which the synchronization detection is first executed is 2003.2 MHz, since the BSS_UE (0) width is 3.2 MHz, next candidate frequency becomes 2006.4 MHz to exceed a frequency band, and next candidate frequency ceases to exist. Meanwhile, in the exemplary embodiment described here, the set value is used for the convenience of the description, and is not a specifically-used value.

At step 4, when it is determined that next candidate frequency by the band search of the BSS_UE (0) width exists, next candidate frequency is set at step 5, and synchronization detection is executed at step 2.

At step 4, when it is determined that next candidate frequency by the band search of the BSS_UE (0) width does not exist, that is, when it is determined that detection of the effective frequencies, that is executed by a band search of the BSS_UE (0) width, has been completed, the process next moves to channel band 2.

In channel band 2, synchronization detection is executed at step 6 for the receiving side candidate frequency of the BSS_UE (0) width. Next, it is determined at step 7 whether or not the effective frequency has been detected. When the effective frequency has been detected, the process is completed.

On the other hand, when the effective frequency is not detected, a determination is made at step 8 whether or not next receiving side candidate frequency by the band search of the BSS_UE (0) width exists in channel band 2.

When a determination is made at step 8 that next candidate frequency by the band search of the BSS_UE (0) width exists, next candidate frequency is set at step 9, and the synchronization detection is executed at step 6.

When a determination is made at step 8 that next candidate frequency by the band search of the BSS_UE (0) width does not exist, that is, when it is determined that that detection of the effective frequencies by the bands search of the BSS_UE (0) width has been completed in channel 2, since the band searches of the first stage in all channel bands have been completed, the value of BSS_UE (0) and the value of the Raster are compared at step 10 to determine whether or not the band searches of all stages have been completed. Here, it is assumed that the value of the Raster is 200 kHz. And, a value of BSS_UE (k) is an integral multiple of the value of the Raster.

Since the value of BSS_UE (0) is larger than the value of the Raster, k=k+1 at step 11, and the same process as that of BSS_UE (0) is executed for BSS_UE (1) which is a next stage.

As long as the effective frequency is not detected in any one of BSS_UE (k), the process of the steps 2 to 9 is executed until a value of BSS_UE (k) becomes equal to or less than the value of the Raster. As described in FIGS. 4A to C, while the amount of receiving side frequency change is being switched from a large value to a small value, that is, while the candidate frequency is being sequentially and gradually switched from a roughly-thinned one to a not-thinned one in the predetermined frequency band, the synchronization detection is executed in channel band 1 and channel band 2. When the effective frequency is not detected even if the value of BSS_UE (k) becomes equal to or less than the value of the Raster, it is determined that the effective frequency does not exist.

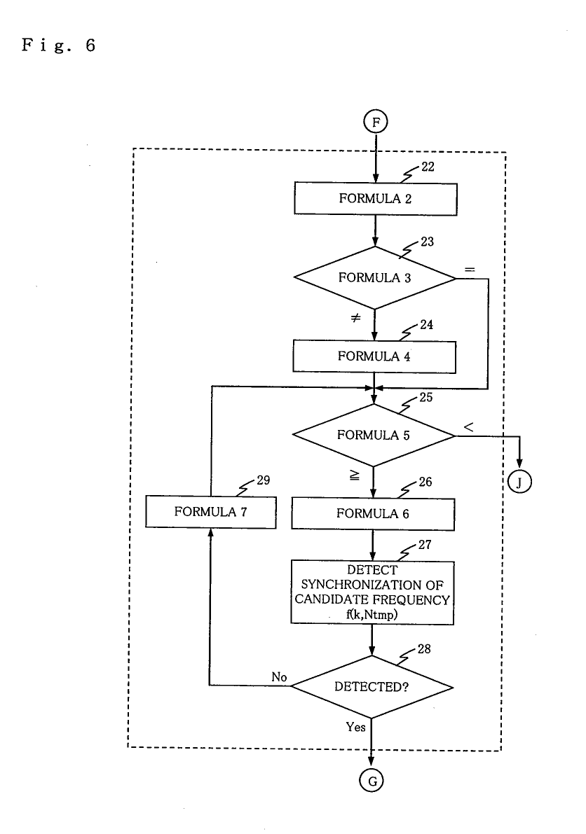

The k-th stage band search of each channel band illustrated by a dash line of a flowchart illustrated in FIG. 5 will be more specifically described by referring to FIG. 6.

Here, it is assumed that the band width of the synchronization signal is SCH_BW. And, it is assumed that a lower limit frequency of the search frequency band of each channel band in which the effective frequency is detected is f_L, and an upper limit frequency is f_H. F, G, and J illustrated in FIG. 6 correspond to the arrows of A, B, and C illustrated in FIG. 5 respectively in the case of channel band 1, and correspond to the arrows of C, D, and E respectively in the case of channel band 2.

First, at step 1 of FIG. 5, which is not included in FIG. 6, as illustrated in Formula 1, a parameter k is set to “0”, which is an initial value, and the synchronization detection is started from the maximum band search step BSS_UE (0).

k=0 (Formula 1)

The band search of the (k+1)-th stage of each channel band starts from F, and Ntmp is calculated at step 22 by using Formula 2. Here, it is assumed that a fractional part of a value in [ ] is dropped.

Nₜₘₚ=[(f_{—}_{L}+SCH_{—}BW/2)/BSS_{—}UE (k)] (Formula 2)

At step 23, (f_L+SCH_BW/2) and (Ntmp×BSS_UE (k)) are compared according to Formula 3.

f_{—L}+SCH_{—}BW/2: Nₜₘₚ×BSS_{—}UE (k) (Formula 3)

When it is determined at step 23 that (f_L+SCH_BW/2) and (Ntmp×BSS_UE (k)) are not equal to each other, Formula 4 is calculated at step 24.

Nₜₘₚ=Nₜₘₚ+1 (Formula 4)

As calculation results of Formula 2, Formula 3, and Formula 4, when a value of a fractional part exists in [ ] in Formula 2, a rounding up operation is executed.

Next, (f_H−SCH_BW/2) and (Ntmp×BSS_UE (k)) are compared by Formula 5, and it is determined at step 25 whether or not the candidate frequency to be band-searched is equal to or less than a value including an allowance of SCH_BW/2 for f_H.

f_{—H}−SCH_{—}BW/2: Nₜₘₚ×BSS_{—}UE (k) (Formula 5)

When it is determined at step 23 that (f_L−SCH_BW/2) and (Ntmp×BSS_UE (k)) are equal to each other, the process of step 24 is not executed, but the process of step 25 is executed.

When it is determined at step 25 that (Ntmp×BSS_UE (k)) is equal to or less than (f_H−SCH_BW/2), the candidate frequency f (k, Ntmp) is calculated at step 26 according to Formula 6.

f (k, Nₜₘₚ)=BSS_{—}UE (k)×Nₜₘₚ (Formula 6)

Next, the synchronization detection is executed at step 27 for the candidate frequency f (k, Ntmp) calculated according to Formula 6, and it is determined at step 26 whether or not the synchronization has been detected, and when the synchronization has been detected, the band search process is completed.

On the other hand, when the synchronization is not detected at step 28, a value of Ntmp is increased by “1” according to Formula 7 at step 29, and the process of step 25 is executed again.

Nₜₘₚ=Nₜₘₚ+1 (Formula 7)

When it is determined at step 25 that (Ntmp×BSS_UE (k)) is a larger value than (f_H−SCH_BW/2), the process moves to the next channel band or step 10 of FIGS. 5 through J. A value of k is updated at step 11, and the process of step 22 is executed again.

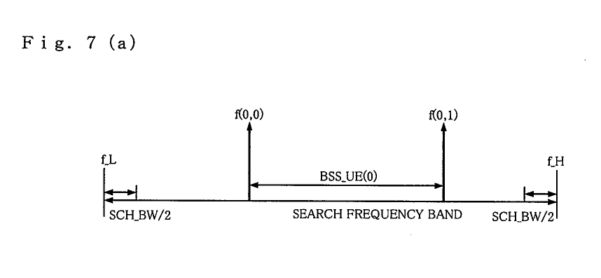

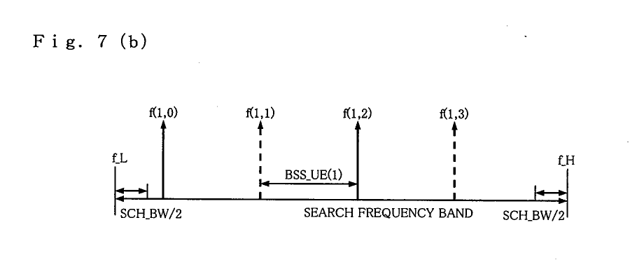

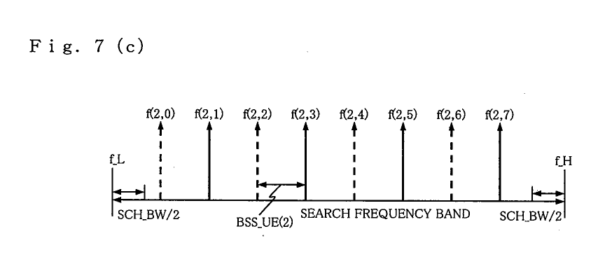

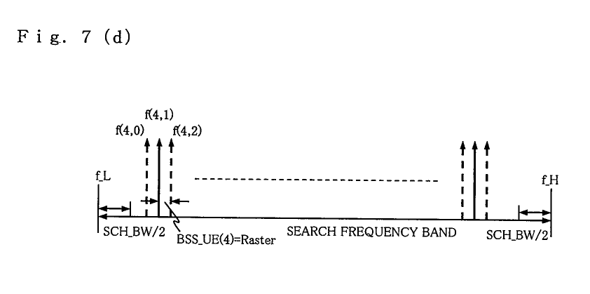

The stage band search process described by using the flowchart illustrated in FIG. 6 will be described as referring to FIGS. 7A to D. Here, for the sake of simplicity, a detailed description will be made of detecting the search band of one channel band.

As illustrated in FIG. 7A, in the first stage, the synchronization of the candidate frequency f (0, 0) and f (0, 1) is detected, the candidate frequencies existing in an area including allowances of SCH_BW/2 at an upper limit and a lower limit of the search frequency band (f_L to f_H) respectively. In this case, the difference between the f (0, 0) and the f (0, 1) is BSS_UE (0).

As illustrated in FIG. 7B, in the second stage, while the search frequency band includes four candidate frequencies of f (1, 0) to f (1, 3) and the candidate frequencies are separated by BSS_UE (1), it has been already tried in the first stage detecting synchronization for f (1, 1) and f (1, 3) illustrated by a dash line arrow has already been tried, but synchronization has not been detected, so that an operation to detect the synchronization for f (1, 1) and f (1, 3) is not tried again.

As illustrated in FIG. 7C, in the third stage, while the search frequency band includes eight candidate frequencies of f (2, 0) to f (2, 7), the candidate frequencies being separated by BSS_UE (2), it has been already tried in the first stage and second stage detecting synchronization for f (2, 0), f (2, 2), f (2, 4), and f (2, 6) illustrated by a dash line arrow has already been tried, but synchronization has not been detected, so that an operation to detect the synchronization for f (2, 0), f (2, 2), f (2, 4), and f (2, 6) is not tried again.

As illustrated in FIG. 7D, in the fifth stage, since BSS_UE (4) is equal to the Raster, every band search can be executed in an accuracy of the Raster as in general cases.

For the sake of simplicity, a description has been made of detecting the search band of one channel band. When the synchronization is detected for a plurality of channel bands, as illustrated in FIGS. 4A to C, after synchronization detection is executed for the candidate frequencies (#1 and #2) in channel band 1 of the first stage, the synchronization detection is executed for the candidate frequencies (#3 and #4) in channel band 2 of the first stage. Next, after the synchronization detection is executed for the candidate frequencies (#5 and #6) in channel band 1 of the second stage, the synchronization detection is executed for the candidate frequencies (#7 and #8) in channel band 2 of the second stage. Next, after the synchronization detection is executed for the candidate frequencies (#9, #10, #11, and #12) in channel band 1 of the third stage, the synchronization detection is executed for the candidate frequencies (#13, #14, #15, and #16) in channel band 2 of the third stage.

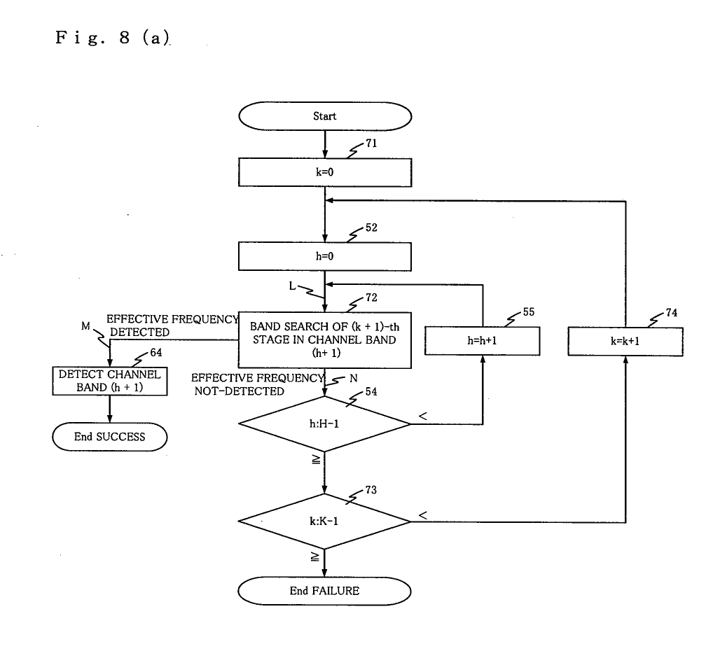

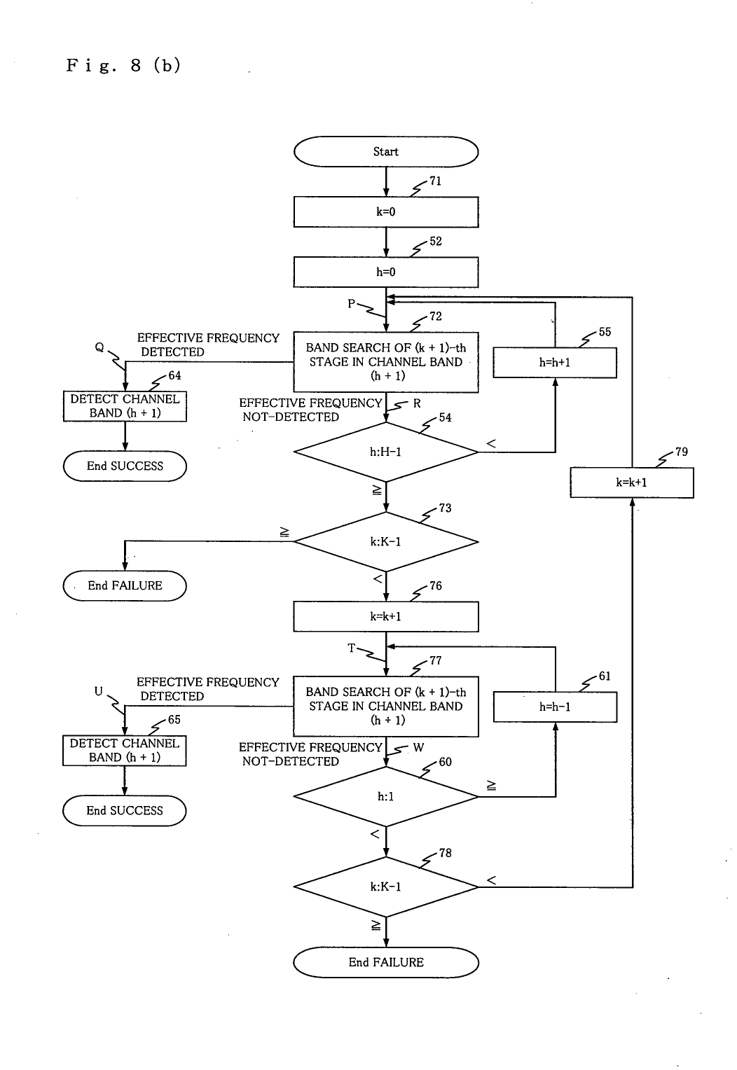

In the stage band search method, since the probability that the effective frequency exists is higher in the early stage band search, if the priority order i of FIG. 3A is replaced by the stage k, the process becomes equivalent. FIG. 8A is such an exemplary embodiment in which channel bands 1 to H are band-searched.

First, the parameter k is set “0”, which is an initial value, at step 71, and the parameter h is set to “0”, which is an initial value at step 52. The band search of the first stage in channel band 1 is executed at step 72. When the effective frequency is detected, channel band (h+1) is specified at step 64, and the process is completed.

Here, the detailed content of step 72 is the same as that of FIG. 6. F, G, and J illustrated in FIG. 6 correspond to arrows L, M, and N illustrated in FIG. 8A.

On the other hand, when the effective frequency has not been detected, it is determined at step 54 whether or not the band searches of the first stage have been completed in all of H channel bands. When it is determined that the band searches of the first stage have not been completed in all of H channel bands, the process moves to next channel band at step 55, and searching the frequency band of the first stage of channel band 2 is executed at step 72.

On the other hand, if it is determined at step 54 that the band searches of the first stage of all of H channel bands have been completed, it is determined at step 73 whether or not the band searches of all of K stages, which are a maximum number of stages, have been completed. When it is determined that the band searches of all of K stages have not been completed, the process moves to the next stage at step 74. Next, the parameter h is set to “0”, which is an initial value, at step 52, and the band search of the second stage in channel band 1 is executed at step 72. The maximum number of stages K is, for example, “5” in the example of table 1.

On the other hand, if it is determined at step 73 that the band searches of all of K stages have been completed, it is determined that the effective frequency does not exist in all channel bands.

By utilizing the channel band information specified at step 65 described in FIG. 3B, in the fixed channel band, it is possible to search for the frequency bands of all stages in more detail, and to specify area information of a country, and the like from the relation between the previously-stored channel band information and area information.

An application of FIG. 8A will be described as referring to FIG. 8B.

Operations of step 71, step 52, step 72, step 64, step 54, and step 55 are the same as those of FIG. 8A. F, G, and J illustrated in FIG. 6 correspond to arrows P, Q, and R illustrated in FIG. 8B.

It is determined at step 73 whether or not the band searches of all of K stages, which are a maximum number of stages, have been completed. When it is determined that the band searches of all of K stages have not been completed, the process moves to the second stage at step 76. Here, since h=H−1, the band search of the second stage in channel band H is executed at step 77. Here, when the effective frequency has been detected, channel band (h+1) is specified at step 65, and the process is completed.

Here, detailed content of step 77 is the same as that of FIG. 6. F, G, and J illustrated in FIG. 6 correspond to arrows T, U, and W illustrated in FIG. 8B.

On the other hand, when the effective frequency has not been detected, it is determined at step 60 whether or not the band searches of the second stage in all of H channel bands have been completed. When it is determined that the band searches of the second stage in all of H channel bands have not been completed, “1” is subtracted from h at step 61, the process moves to the next channel band, and at step 77, the band search of the second stage of channel band H−1 is executed.

On the other hand, when it is determined at step 60 that the band searches of the second stage of all of H channel bands have been completed, it is determined at step 78 whether or not the band searches of all of K stages, which are a maximum number of stages, have been completed. When it is determined that the band searches of all of K stages have not been completed, the process moves to the next stage at step 79. In this case, since h=0, the band search of the third stage in channel band 1 is executed at step 72.

On the other hand, if it is determined at step 78 that the band searches of all of K stages have been completed, it is determined that the effective frequency does not exist in all the channel bands.

The following is an advantage of this method. The h is not frequently initialized in FIG. 8B, so that the channel band in which detection is tried is not changed so frequently.

By utilizing the channel band information specified at step 64 or step 65, in the fixed channel band, it is also possible to band-search all the stages in more detail, and to specify area information of a country, and the like from the relation between the previously-stored channel band information and area information.

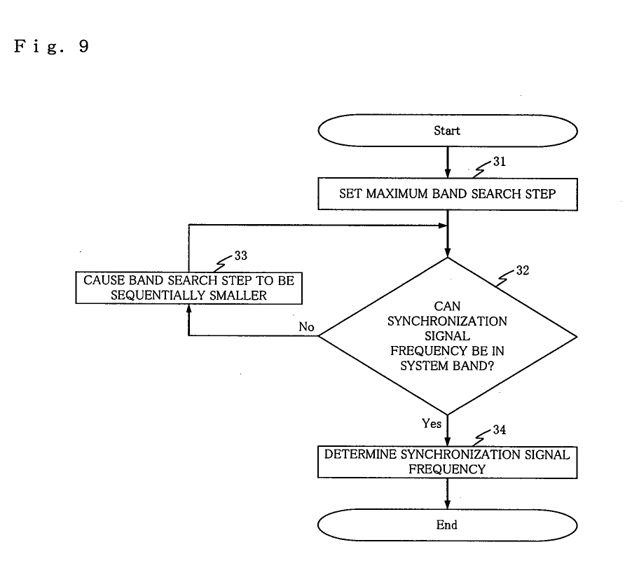

Such a procedure will be described by referring to FIG. 9 in which the transmission frequency of the synchronization signal is determined according to the stage band search method in transmitter 1 of the communication system illustrated in FIG. 2.

It is assumed that a determination is made that the step size of the frequency, in which an effort was made to detect the synchronization signal, gradually changes. On the other hand, transmitter 1 determines the frequency fp_s1 which transmits the synchronization signal so that the band search step becomes the largest in the plurality of band search steps for securing the band (SCH_BW) of the synchronization signal in the transmission band (fL_s1 to fH_s1) of the system.

First, the maximum band search step is set at step 31, the maximum band search step being in a condition in which the frequencies are most roughly thinned. A synchronization signal frequency, which inserts the synchronization signal with a prescribed formula by using the set band search step, is calculated as a transmitting side candidate frequency. It is determined at step 32 whether or not the synchronization signal can be transmitted by the calculated transmitting side candidate frequency, that is, the transmitting side candidate frequency that exists in a system frequency band.

When it is determined that the synchronization signal can not be transmitted, at step 33, the band search step is sequentially and gradually set to a smaller value, that is, the band search step is changed to the band search step in which the frequencies are not thinned. The transmitting side candidate frequency is calculated again by using the changed band search step. It is determined whether or not the synchronization signal can be transmitted by the calculated transmitting side candidate frequency, and when it is determined that the synchronization signal can be transmitted, at step 34, the transmitting side candidate frequency is determined as the synchronization signal frequency.

As described above, by setting the synchronization signal frequency of the transmitting side to an integral multiple of as large a band search step as possible, the probability that the effective frequency exists is increased which is a frequency of an integral multiple of BSS_BS (k), in which k is small, and the synchronization signal frequency can be caused to be the frequency whose priority order is high.

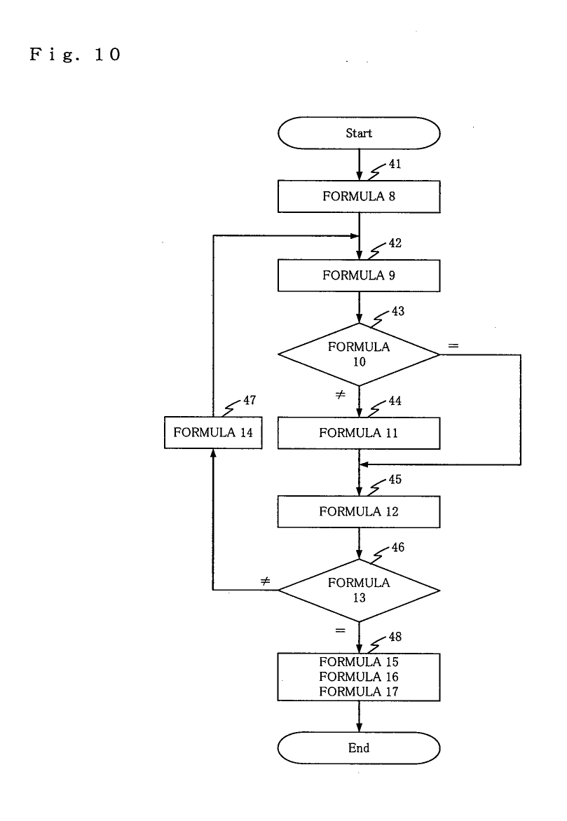

Another determining method will be described by referring to FIG. 10 for such a procedure in which the transmission frequency of the synchronization signal is determined in the stage band search method in transmitter 1 of the communication system illustrated in FIG. 2.

Here, it is defined that BSS_tmp is a parameter for obtaining the maximum band search step BSS_s1 which is the amount of maximum transmitting side frequency change.

First, the minimum value of the band search step is set. That is, Raster, which is a value of the Raster, is set as an initial value of the band search step according to Formula 8 at step 41.

BSS_tmp=Raster (Formula 8)

In this case, when the Raster is not defined, the previously-set minimum value of the band search step is set.

At step 42, NL_tmp is calculated by using Formula 9. Here, it is assumed that a fractional part of a value in [ ] is dropped.

N_{L}_{_{—}}ₜₘₚ=[(f_{L}_{_{—}}ₛ₁+SCH_{—}BW/2)/BSS_{—}tmp] (Formula 9)

At step 43, (fL_s1) and (NL_tmp×BSS_tmp) are compared by Formula 10.

f_{L}_{_{—}}ₛ₁:N_{L}_{_{—}}ₜₘₚ×BSS_{—}tmp (Formula 10)

When it is determined at step 43 that (fL_s1) and (NL_tmp×BSS_tmp) are not equal to each other, the calculation of Formula 11 is executed at step 44.

N_{L}_{_{—}}ₜₘₚ=N_{L}_{_{—}}ₜₘₚ+1 (Formula 11)

Here, as calculation results of Formula 9, Formula 10, and Formula 11, when a value of a fractional part exists in the division in [ ] of Formula 9, an operation for rounding up the value is executed.

At step 45, a parameter NH_tmp is calculated according to Formula 12. When it determined at step 43 that fL_s1 and (NL_tmp×BSS_tmp) are equal to each other, the process of step 44 is not executed, but the process of step 45 is executed.

N_{H}_{_{—}}ₜₘₚ=[(f_{H}_{_{—}}ₛ₁+SCH_{—}BW/2)/BSS_{—}tmp] (Formula 12)

After that, at step 46, NL_tmp and NH_tmp are compared by Formula 13.

NL_tmp:NH_tmp (Formula 13)

When it is determined that NL_tmp and NH_tmp are not equal to each other, since BSS_tmp does not reach the maximum value, at step 47, a value of the band search step BSS_tmp is calculated as a large value according to Formula 14. Next, the processes of steps 42 to 45 are executed again.

BSS_{—}tmp=BSS_{—}tmp×2 (Formula 14)

On the other hand, when it is determined that NL_tmp and NH_tmp are equal to each other, since BSS_tmp reaches the maximum value, the frequency fP_s1 for transmitting the synchronization signal is determined at step 48 according to Formula 15, Formula 16, and Formula 17.

Nₛ₁=N_{L}_{_{—}}ₜₘₚ (Formula 15)

BSS_s1=BSS_tmp (Formula 16)

fₚ_{_{—}}ₛ₁=Nₛ₁×BSS_{—}s1 (Formula 17)

As described above, the frequency for transmitting the synchronization signal can be determined in the transmitting side even though the band search step is changed from a larger value to a smaller value, or from a smaller value to a larger value.

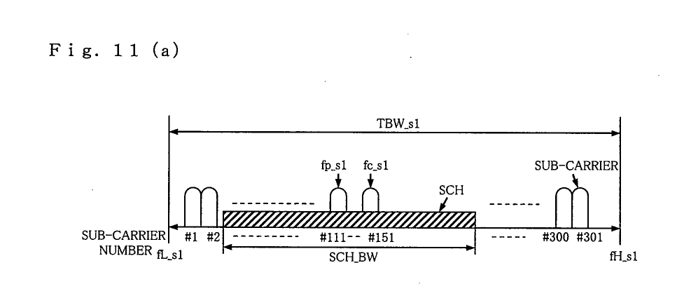

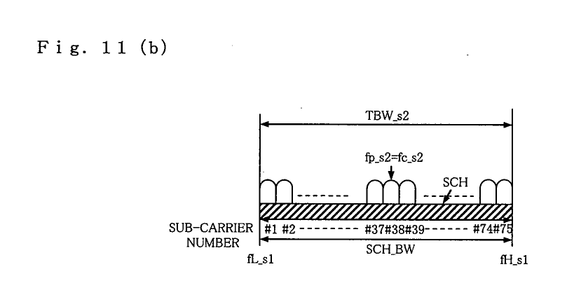

In FIG. 11A, it is assumed that a transmission band of the system TBW_s1=5 MHz, and OFDM signal formed with 301 sub-carriers is transmitted. And, fc_s1 is a central frequency of system s1. It is assumed that a band SCH_BW of the synchronization signal SCH is 1.25 MHz, and the central frequency fp_s1 of the synchronization signal can be independently set from the central frequency fc_s1 of the system. Here, an OFDM signal is assumed.

In this case, since TBW_s1 is larger than SCH_BW, when the Raster is a small enough value, the large BSS_s1 can be selected in the process described by using the flowchart of FIG. 9 or FIG. 10.

An exemplary example of a specific value will be described below.

It is assumed as a specific exemplary example that fL_s1=2130.9 MHz, fc_s1=2133.4 MHz, fH_s1=2135.9 MHz, Raster=200 kHz, a maximum value of the band search step is 6.4 MHz, and a sub-carrier interval Δf=15 kHz. Here, such a procedure for determining the frequency for transmitting the synchronization signal will be described as sequentially causing the band search step to become smaller from the maximum value of the band search step according to the flowchart illustrated in FIG. 9.

First, in the maximum band search step 6.4 MHz, it is determined whether or not the synchronization signal frequency, which is an integral multiple of the band search step 6.4 MHz, exists from the band 2131.525 MHz to 2135.275 MHz in which the allowance of SCH_BW is secured in the transmission band. Here, the synchronization signal frequency, which is an integral multiple of the band search step 6.4 MHz, does not exist.

Thus, the band search step is caused to be 3.2 MHz of the next stage, and it is determined whether or not the synchronization signal frequency, which is an integral multiple of the band search step 3.2 MHz, exists from the band 2131.525 MHz to 2135.275 MHz. In this case, 2134.4 MHz exists as a candidate.

However, the difference between 2134.4 MHz and fc_s1 is 1 MHz, and 2134.4 MHz can not be divided by 15 kHz which is Δf. Since this means that this frequency is not the sub-carrier frequency, the sub-carrier in which the synchronization signal is allocated does not correspond to the sub-carrier frequency of the system, so that it is determined improper that 2134.4 MHz is set to fp_s1, and the band search step is caused to be 1.6 MHz of next stage. Two candidates of 2132.8 MHz and 2134.4 MHz exist as the synchronization signal frequency which is an integral multiple of the band search step 1.6 MHz from band 2131.525 MHz to 2135.275 MHz.

Here, the difference between 2132.8 MHz and fc_s1 is 600 kHz, and 2132.8 MHz can be divided by Δf, so that it is determined that the sub-carrier in which the synchronization signal is allocated corresponds to the sub-carrier frequency of the system, and fc_s1 is caused to be 2132.8 MHz. In this case, fp_s1 is a sub-carrier number 111.

Next, in FIG. 11B, it is assumed that the transmission band of the system is TBW_s2=1.25 MHz, and that the OFDM signal formed with 75 sub-carriers is transmitted. And fc_s2 is the central frequency of the system s2. It is assumed that the band SCH_BW of the synchronization signal SCH is 1.25 MHz. Here, an OFDM signal is assumed.

For example, in the process described by using the flowchart illustrated in FIG. 10, since TBW_s2=SCH_BW, BSS_s2=Raster, and fp_s2=fc_s2.

In the above description, while the frequency of the synchronization is an integral multiple of the band search step in Formula 6 and Formula 17, the frequency of the synchronization may be calculated according to Formula 18 and Formula 19 by adding an offset to the integral multiple of the band search step.

fₚ_{_{—}}ₛ₁_{_{—}}_{offset}=f_{offset}+Nₛ₁×BSS_{—}s1 (Formula 18)

f_{offset}(k, Nₜₘₚ)=f_{offset}+BSS_{—}UK (k)×Nₜₘₚ (Formula 19)

Together with Formula 18 and Formula 19, Formula 2 in the process described by using the flowchart illustrated in FIG. 6 is replaced by Formula 20, Formula 3 is replaced by Formula 21, Formula 5 is replaced by Formula 22, and Formula 6 is replaced by Formula 19.

Nₜₘₚ=[(f_{—L}−f_{offset}+SCH_{—}BW/2)/BSS_{—}UK (k)] (Formula 20)

f_{—L}−f_{offset}+SCH_{—}BW/2:Nₜₘₚ×BSS_{—}UK (k) (Formula 21)

f_{—H}−f_{offset}−SCH_{—}BW/2:Nₜₘₚ×BSS_{—}UK (k) (Formula 22)

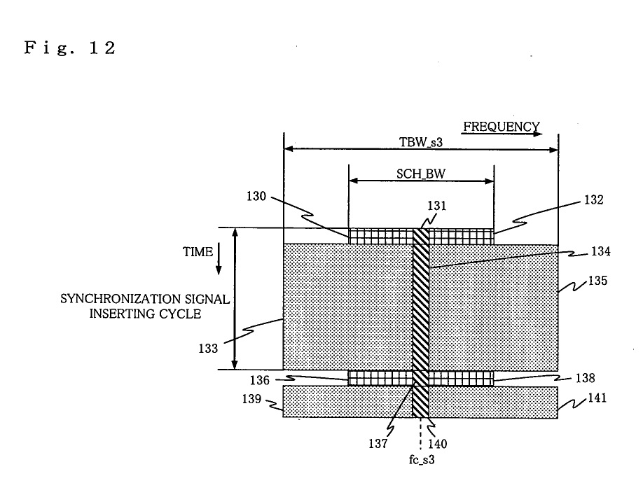

As illustrated in FIG. 12, in LTE of 3GPP, since the configuration is a simple configuration in which a DC (Direct Current) component of a receiver is cut, a DC sub-carrier, which is different from a normal sub-carrier, is defined, as the sub-carrier of the central frequency of the system band. In the defined sub-carrier, data is not transmitted. The system s3 is configured with normal data transmission sub-carriers 133, 135, 139, and 141, and DC sub-carriers 134 and 140 which do not transmit data of the central frequency fc_s3 of the system band TBW_s3. Sub-carriers 130, 132, 136, 138 of the synchronization signal of the band SCH_BW are inserted in a prescribed synchronization signal inserting cycle, and central frequency areas 131 and 137 become areas in which the synchronization signal is not transmitted.

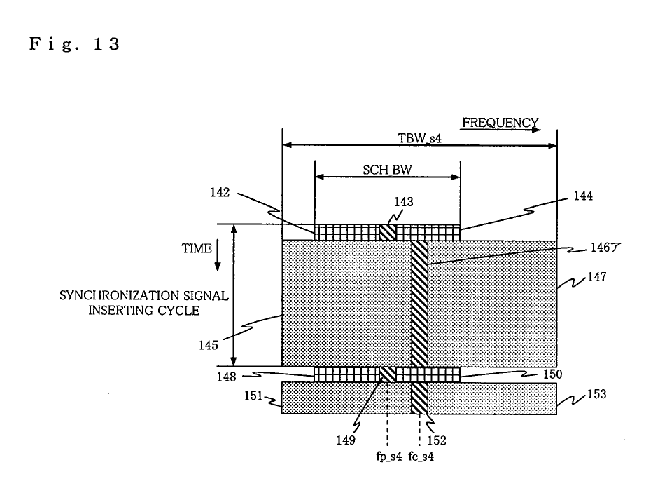

As illustrated in FIG. 13, the system s4 is configured with normal data transmission sub-carriers 145, 147, 151, and 153, and DC sub-carriers 146 and 152 which do not transmit data of the central frequency fc_s4 of the system band TBW_s4. Sub-carriers 142, 144, 148, 150 of the synchronization signal, which is shifted from the central frequency fc_s4, are inserted in a prescribed synchronization signal inserting cycle, and the sub-carriers, which are central frequency areas 143 and 149 of the central frequency fp_s4, do not transmit the synchronization signal like DC sub-carriers 146 and 152.

In the relation between the sub-carrier interval and the receiver, in the system which does not need to provide the DC sub-carrier, the configuration in which data is not included at the central frequency fc of the system can be realized by setting the central frequency fc to a frequency between the sub-carriers.

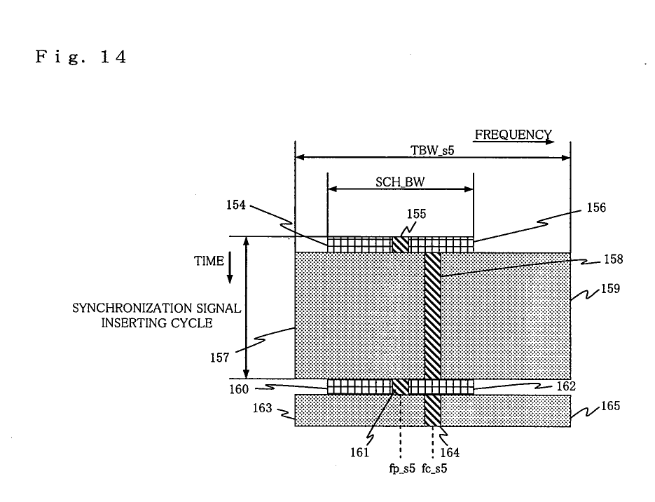

As illustrated in FIG. 14, system s5 is configured with normal data transmission sub-carriers 157, 159, 163, and 165, and the central frequency fc_s5 of the system band TBW_s5 is in frequency areas 158 and 164 between data communication sub-carriers 157 and 163, and data communication sub-carriers 159 and 165. Sub-carriers 154, 156, 160, and 162 of the synchronization signal which is shifted from the central frequency fc_s5 are inserted in a prescribed synchronization signal inserting cycle, and the central frequency fc_s5 is in frequency areas 155 and 161 between sub-carriers 154 and 160 of the synchronization signal, and sub-carriers 156 and 162 of the synchronization signal respectively.

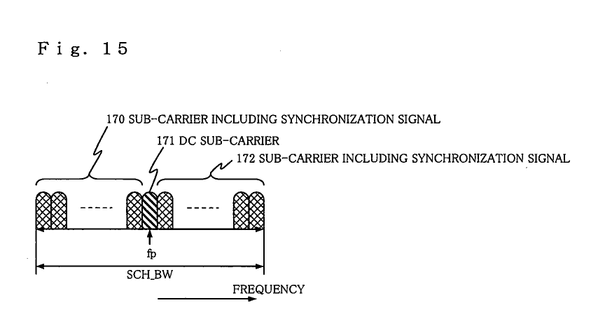

As illustrated in FIG. 15, the synchronization signal is configured with sub-carriers 170 and 172, which include the synchronization signal, and DC sub-carrier 171. DC sub-carrier 171 is allocated at the central frequency fp of the synchronization signal, and does not include the synchronization signal.

In the system which does not need to provide the DC sub-carrier, the configuration in which the synchronization signal is not included at the central frequency fp of the synchronization signal can be realized by setting the fp to a frequency between the sub-carriers that include the synchronization signal.

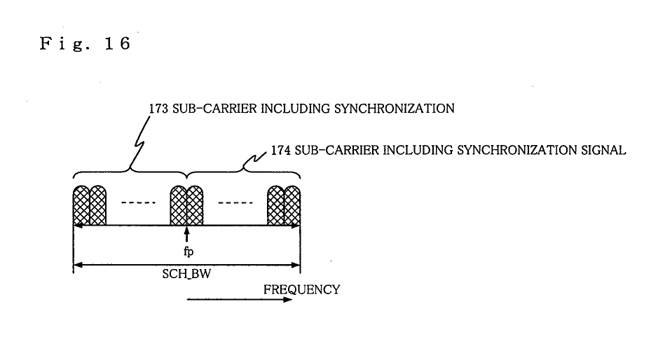

As illustrated in FIG. 16, the synchronization signal is configured with sub-carriers 173 and 174 that include the synchronization signal. The central frequency fp of the synchronization signal is set so as to be a frequency between sub-carrier 173 that include the synchronization signal, and sub-carrier 174 that include the synchronization signal.

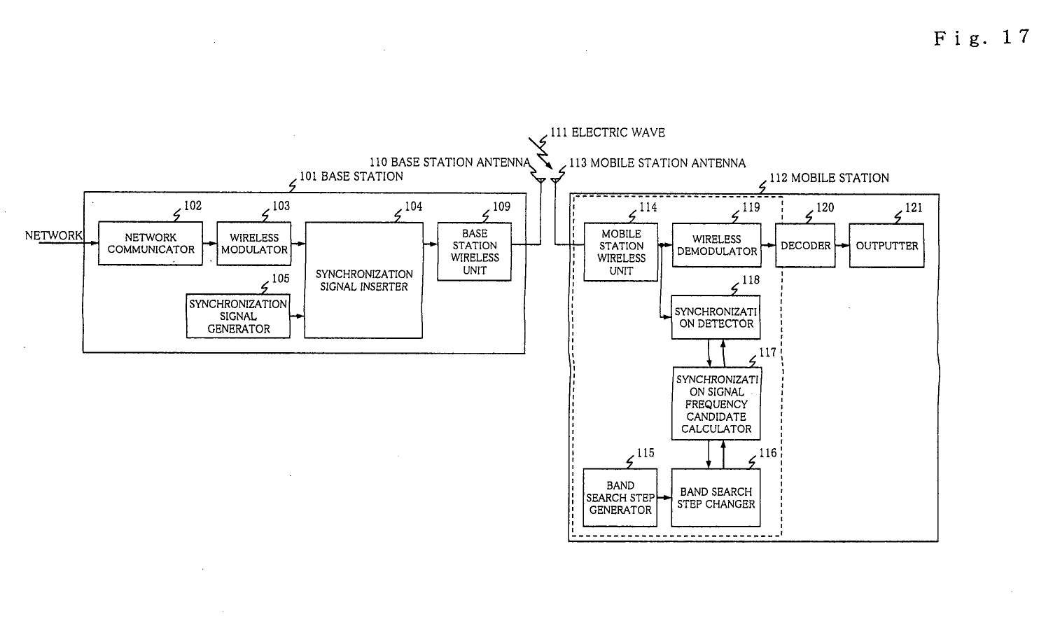

As illustrated in FIG. 17, a communication system is configured with base station 101 and mobile station 112. FIG. 17 illustrates an exemplary embodiment of the communication system in which electric wave 111 is transmitted and received between base station 101 and mobile station 112, and the communication is realized.

In addition, base station 101 is configured with network communicator 102, wireless modulator 103, synchronization signal inserter 104, synchronization signal generator 105, base station wireless unit 109, and base station antenna 110.

Mobile station 112 is configured with mobile station antenna 113, mobile station wireless unit 114, band search step generator 115, band search step changer 116, synchronization signal frequency candidate calculator 117, synchronization detector 118, wireless demodulator 119, decoder 120, and output unit 121.

Network communicator 102 receives a signal received from a network. Wireless modulator 103 executes a modulation such as IFFT (Inverse Fast Fourier Transform) or FFT (Fast Fourier Transform) to execute, for example, the OFDM communication for the signal received by network communicator 102. Synchronization signal generator 105 generates a delay wave-detectable signal in which the same pattern is repeated on a time axis to synchronize with mobile station 112, or generates a synchronization signal which is a synchronization wave-detectable and well-known signal. Synchronization signal inserter 104 inserts the synchronization signal generated by synchronization signal generator 105 by using, as a center, a frequency in which mobile station 112 can detect the synchronization signal in as large a band search step as possible. Base station wireless unit 109 includes a transmitter and an amplifier, and transmits an output signal of synchronization signal inserter 104 as electric wave 111 from base station antenna 110.

Mobile station wireless unit 114 includes a receiver and an amplifier, and receives electric wave 111 transmitted from base station antenna 110 via mobile station antenna 113. Band search step generator 115 stores or generates a plurality of band search steps. Band search step changer 116 selects one band search step from among the plurality of band search steps. In this case, band search step changer 116 initially selects a large value, and sequentially and gradually selects a smaller value. Synchronization signal frequency candidate calculator 117 calculates a candidate frequency of the synchronization signal from the band search step selected by band search step changer 116 by using a prescribed formula. Synchronization detector 118 detects whether or not the candidate frequency includes the synchronization signal by using the delay wave detection or the synchronization wave detection. Wireless demodulator 119 executes FFT, IFFT, or the like for OFDM demodulation by using a timing at which the synchronization is detected by synchronization detector 118. Decoder 120 decodes a signal demodulated by wireless demodulator 119. Output unit 121 displays a signal decoded by decoder 120 or outputs it the signal as a voice from a speaker.

Here, if the synchronization detection has failed at synchronization detector 118, synchronization signal frequency candidate calculator 117 designates the next candidate frequency according to a prescribed formula from the same band search step as the previous one, and synchronization detector 118 executes the synchronization detection again.

If the candidate frequency ceases to exist in the search band, the candidate frequency being designated by calculating from the same band search step, band search step changer 116 selects a next band search step, synchronization signal frequency candidate calculator 117 designates a candidate frequency according to a prescribed formula from the new band search step, and synchronization detector 118 executes the synchronization detection again.

In an exemplary embodiment illustrated in FIG. 17, wireless modulator 103 and wireless demodulator 119 may also use a communicating scheme such as MC-CDMA (Multi-Carrier Code Division Multiple Access) and FDMA (frequency Division Multiple Access) other than OFDM. The communicating scheme may be also a wire communicating scheme other than a wireless communicating scheme.

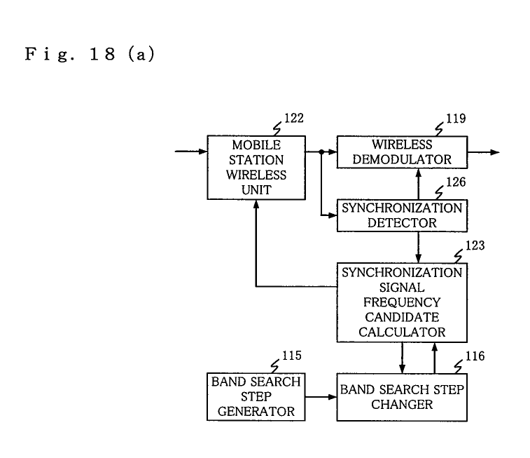

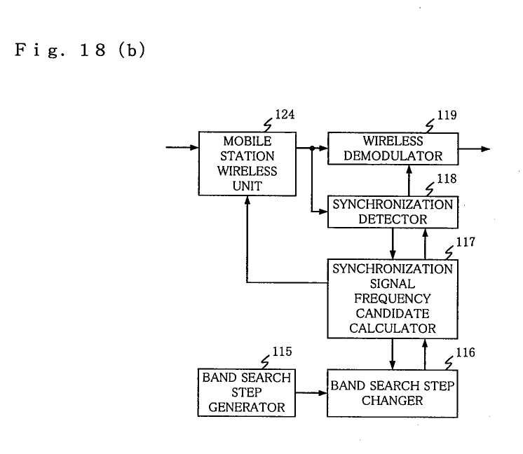

As illustrated in FIG. 18A, in the present exemplary embodiment, configurations of mobile station wireless unit 122, synchronization signal frequency candidate calculator 123, and synchronization detector 126 are different as compared with the part illustrated by the dash line in the exemplary embodiment illustrated in FIG. 17.

Synchronization signal frequency candidate calculator 123 controls an oscillator of mobile station wireless unit 122, the oscillator being configured with super-heterodyne and by direct conversion, and controls a synchronization signal candidate frequency to be inputted to synchronization detector 126 as a base band frequency (=0 Hz), or as a certain intermediate frequency.

That is, if the synchronization signal candidate frequency of the n-th stage is fpch_c(n) and if a wireless unit frequency of this timing n is fradio (n), the wireless unit frequency being configured by down conversion in mobile station wireless unit 122, fpch_c(n) is expressed by Formula 23. However, in this case, a data delay from mobile station wireless unit 122 to synchronization detector 126 is not meaning.

f_{pch}_{_{—}}_{c} (n)=f_{radio} (n) (Formula 23)

The relations with functions f (k, Ntmp) illustrated in FIGS. 7A to D are expressed by Formula 24, Formula 25, Formula 26, and Formula 27.

f_{pch}_{_{—}}_{c} (0)=f (0, 0) (Formula 24)

f_{pch}_{_{—}}_{c} (1)=f (0, 1) (Formula 25)

f_{pch}_{_{—}}_{c} (2)=f (1, 0) (Formula 26)

f_{pch}_{_{—}}_{c} (3)=f (1, 2) (Formula 27)

Thus, like f (k, Ntmp), a signal whose center is fpch_c (n) is inputted to synchronization detector 126. Synchronization detector 126 executes the synchronization detection by constantly using the same “0” Hz or intermediate frequency as a center.

As illustrated in FIG. 18B, in the present exemplary embodiment, a configuration of mobile station wireless unit 124 is different as compared with the part illustrated by the dash line in the exemplary embodiment illustrated in FIG. 17.

In mobile station wireless unit 124, if a wireless unit frequency designated by the down conversion of a frequency at a timing n is fradio (n) and if a digital frequency digitally designated by synchronization detector 118 is fdig (n), the relation between fradio (n) and fdig (n) is expressed by Formula 28. However, in this case, a data delay from mobile station wireless unit 124 to synchronization detector 118 is not meaning.

f_{pch}_{_{—}}_{c} (n)=f_{radio} (n)+f_{dig} (n) (Formula 28)

Since the wireless unit frequency fradio (n) designated in mobile station wireless unit 124 is analog, if the wireless unit frequency fradio (n) is changed, some time is necessary to stabilize the frequency so that much time is needed if the frequency is often changed.

On the other hand, such a designating method in which the digital frequency fdig (n) is designated by synchronization detector 118 is generally such a method in which the received signal is multiplied by sine and/or cosine signals. When delay wave detection is used, such a method can be used in which a filter that allows a received signal to pass through is changed. When the synchronization wave detection is executed by using a replica signal, there is a method for detecting the correspondence relationship by shifting and converting signals on a frequency axis when converting (IFFT and FFT) from a frequency axis to a time axis in a replica generation. The synchronization detection in this case detects the correspondence relationship with a well-known signal, or detects the correspondence relationship with the replica signal obtained by calculating the replica signal from a well-known signal by using IFFT, FFT, and the like. A plurality of the replica signals are generated from the plurality of signals shifted on a frequency axis, and the generated replica signals may be stored and used.

In this case, storage capacity becomes a problem if the synchronization detection is executed by using the plurality of replicas which are previously calculated and stored.

Thus, if an area in which synchronization detection can be executed by changing only the digital frequency is Δfdig, when the calculated fpch_c (n) satisfies Formula 29, the frequency is designated by controlling only the synchronization detector. When the calculated fpch_c (n) does not satisfy Formula 29, such a method can be used in which the frequency is designated by controlling mobile station wireless unit 124, or by controlling both of mobile station wireless unit 124 and synchronization detector 118.

f_{radio} (n−1)−f_{dig}/2<f_{pch}_{_{—}}_{c} (n)<f_{radio} (n−1)+f_{dig}/2 (Formula 29)

As described above, in the present invention, when an attempt is made to detect the synchronization signal from among a plurality of discrete frequency bands (referred to as a plurality of channel bands), after a transmitter transmits the synchronization signal to synchronize the system frequency band, and after a receiver detects the synchronization signal whose order of priority is higher in each of a plurality of channel bands for frequencies in which detection an attempt has been made to detected the synchronization signal, the frequency detecting process can be speeded up, which is effective among a plurality of channel bands by sequentially detecting the synchronization signal of the frequencies whose priority order is lower.

While an exemplary embodiment of the present invention has been described in specific terms, such description is for illustrative purpose only, and it is to be understood that changes and variations may be made without departing from the spirit or scope of the following claims.

What is claimed is:

1. A communication system, comprising:
a transmitter for transmitting a synchronization signal for establishing synchronization; and
a receiver for establishing the synchronization by detecting the synchronization signal,
wherein the receiver tries to detect the synchronization signal at frequencies in which the probability that an effective frequency exists is higher to frequencies in which the existence probability is lower among a plurality of discrete frequency bands.

2. The communication system according to claim 1,
wherein the receiver sequentially switches an interval, at which the detection of the synchronization signal has been tried, from a roughly-thinned one interval to a non-thinned one interval from among a plurality of discrete frequency bands, and
the transmitter sets the synchronization signal to be transmitted at the interval roughly thinned one by the receiver.

3. The communication system according to claim 1,
wherein the synchronization is a frequency synchronization, and the process for establishing synchronization is a process for detecting an effective communication frequency,
the receiver sequentially and gradually switches an amount of frequency change from a larger value to a smaller value, calculates a receiving side candidate frequency for detecting the synchronization signal based on the amount of frequency change, and detects the synchronization signal by using the calculated receiving side candidate frequency, and
the transmitter calculates a transmitting side candidate frequency which becomes a candidate of a frequency for transmitting the synchronization signal based on as large the amount of frequency change as possible and when the transmitting side candidate frequency exists in the transmission band of the system, determines the transmitting side candidate frequency as a synchronization signal frequency for transmitting the synchronization signal.

4. The communication system according to claim 1,
wherein the receiver adds an offset to an integral multiple of the amount of receiving side frequency change to cause the receiving side candidate frequency, and
the transmitter adds the offset to an integral multiple of the amount of transmitting side frequency change to cause the transmitting side candidate frequency.

5. The communication system according to claim 4,
wherein the receiver causes the offset to be “0”, and the transmitter causes the offset to be “0”.

6. The communication system according to claim 1,
wherein the transmitter transmits a well-known signal as the synchronization signal, and
the receiver detects a correspondence relationship between the receiving side candidate frequency signal and the well-known signal, or a correspondence relationship between the receiving side candidate frequency signal and a replica signal obtained by calculating the replica signal from the well-known signal by using IFFT or FFT and storing replica signal.

7. The communication system according to claim 1,
wherein the transmitter transmits a signal in which the same signal is repeated as the synchronization signal, and
the receiver detects the synchronization signal by using delay wave detection.

8. The communication system according to claim 1,
wherein the transmitter sets the amount of transmitting side frequency change to an integral multiple of a minimum allocation unit of a central frequency of the system band.

9. The communication system according to claim 1,
wherein the receiver sets the amount of receiving side frequency change to an integral multiple of a minimum allocation unit of a central frequency of the system band.

10. A receiver,
sequentially and gradually switching an amount of previously-set receiving side frequency change from a larger value to a smaller value from among a plurality of discrete frequency bands,
calculating a receiving side candidate frequency for detecting a synchronization signal transmitted from a transmitter based on the amount of transmitting side frequency change, and
detecting the synchronization signal at the calculated receiving side candidate frequency.

11. The receiver according to claim 10,
adding an offset to an integral multiple of the amount of receiving side frequency change; and
causing the receiving side candidate frequency.

12. The receiver according to claim 11,
wherein the offset is caused to be “0”.

13. A method for detecting synchronization in a communication system including a transmitter for transmitting a synchronization signal to establish synchronization in a system frequency band, and a receiver for detecting the synchronization signal in the system frequency band,
wherein the receiver sequentially switches an interval, at which detection of the synchronization signal has been tried, from a roughly-thinned one interval to a non-thinned one interval from among a plurality of discrete frequency bands, and
the transmitter sets the synchronization signal to be detected at the interval roughly thinned by the receiver.

14. The method according to claim 13,
wherein the receiver sequentially and gradually switches an amount of previously-set frequency change from a larger value to a smaller value from among a plurality of discrete frequency bands,
the receiver calculates a receiving side candidate frequency for detecting the synchronization signal based on the amount of receiving side frequency change,
the receiver detects the synchronization signal by using the calculated receiving side candidate frequency,
the transmitter calculates a transmitting side candidate frequency which becomes a candidate of a frequency for transmitting the synchronization signal based on as large an amount of frequency change as possible, the amount of frequency change being calculated based on a band width of the synchronization signal,
the transmitter determines the transmitting side candidate frequency as a synchronization signal frequency for transmitting the synchronization signal when the transmitting side candidate frequency exists in the system frequency band, and
the transmitter transmits the synchronization signal to the receiver by using the synchronization signal frequency.
